(19) United States
(12) Patent Application Publication
(10) Pub. No.: US 2024/0258742 A1
(43) Pub. Date: Aug. 1, 2024

(54) CABLE ASSEMBLY WITH RELEASE MECHANISM

(71) Applicant: 3M INNOVATIVE PROPERTIES COMPANY, St. Paul, MN (US)

(72) Inventors: Chin Hua Lim, Mo Kio (SG); Saujit Bandhu, Sengkang (SG); YunLong Qiao, Bukit Timah (SG); Kok Hoe Lee, Geylang (SG)

(21) Appl. No.: 18/560,454

(22) PCT Filed: Apr. 18, 2022
(86) PCT No.: PCT/IB2022/053613

§ 371 Date: Nov. 13, 2023

Related U.S. Application Data
(60) Provisional application No. 63/188,703, filed on May 14, 2021.

(51) Int. Cl. H01R 13/627; H01R 12/79

(52) U.S. Cl. CPC H01R 13/6275; H01R 12/79

(57) ABSTRACT

A cable assembly is disclosed. The cable assembly includes a housing and a latch connected to the housing, the latch defining a lower pull cross member. The cable assembly also includes a pull disposed proximate the latch. A portion of the pull at least partially travels around the lower pull cross member such that two pull portions extending away from the lower pull cross member are separated by an angle of at least about 30 degrees.

### BACKGROUND

Servers in data centers have ever-increasing data rates. Improved and standardized connectors offer superior mechanical performance, electrical performance, and cost characteristics over current PCB cable assemblies

### SUMMARY

In some aspects of the present disclosure, a cable assembly is disclosed. The cable assembly can include a housing and a latch connected to the housing, and the latch can define a lower pull cross member. A pull can be disposed proximate the latch, and a portion of the pull can at least partially travel around the lower pull cross member such that two pull portions extending away from the lower pull cross member are separated by an angle of at least about 30 degrees.

In some aspects of the present disclosure, a cable assembly is disclosed. The cable assembly can include a housing and a latch connected to the housing. The latch can define an upper portion and a lower portion, and the upper portion can define an upper pull aperture and the lower portion can define a lower pull aperture. A pull can be disposed proximate the latch, and a portion of the pull can be disposed within the lower pull aperture and a portion of the pull can be disposed within the upper pull aperture.

In some aspects of the present disclosure, a cable assembly is disclosed. The cable assembly can include a housing and a latch connected to the housing. The latch can define an upper portion and a lower portion. The upper portion can include an upper pull cross member and the lower portion can define a lower pull cross member. A pull can be disposed proximate the latch, and a portion of the pull can be disposed below the lower pull cross member as measured along a Z axis and a portion of the pull can be looped around the upper pull cross member.

### BRIEF DESCRIPTION OF THE DRAWINGS

FIG. 1 is an upper perspective view of a connector system, showing a mating connector and a cable assembly in an attached position, according to exemplary embodiments of the present disclosure.

FIG. 2 is an upper perspective view of a cable assembly, according to exemplary embodiments of the present disclosure.

FIG. 3 is an upper perspective view of a cable assembly, different from that shown in FIG. 2, according to exemplary embodiments of the present disclosure.

FIG. 4 is an upper perspective view of a cable assembly, shown with the cables removed, according to exemplary embodiments of the present disclosure.

FIG. 5 is an upper perspective view of a latch and a pull, according to exemplary embodiments of the present disclosure.

FIG. 6 is a perspective cross sectional view of a cable assembly, according to exemplary embodiments of the present disclosure.

FIG. 7 is an upper perspective cross sectional view of a latch and a pull, according to exemplary embodiments of the present disclosure.

FIG. 8 is a side elevation view of a latch and a pull, according to exemplary embodiments of the present disclosure.

FIG. 9 is a lower perspective view of a latch and a pull, according to exemplary embodiments of the present disclosure.

FIG. 10 is a cross sectional view of a mating connector, cage, latch, and cable assembly, according to exemplary embodiments of the present disclosure.

FIG. 11 is a top elevation view of a connector system, according to exemplary embodiments of the present disclosure.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

All scientific and technical terms used herein have meanings commonly used in the art unless otherwise specified. The definitions provided herein are to facilitate understanding of certain terms used frequently herein and are not meant to limit the scope of the present disclosure. Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above those other elements.

As used herein, when an element, component or layer for example is described as forming a “coincident interface” with, or being “on” “connected to,” “coupled with” or “in contact with” another element, component or layer, it can be directly on, directly connected to, directly coupled with, in direct contact with, or intervening elements, components or layers may be on, connected, coupled or in contact with the particular element, component or layer, for example. When an element, component or layer for example is referred to as being “directly on,” “directly connected to,” “directly coupled with,” or “directly in contact with” another element, there are no intervening elements, components or layers for example.

As used herein, “have”, “having”, “include”, “including”, “comprise”, “comprising” or the like are used in their open-ended sense, and generally mean “including, but not limited to.” It will be understood that the terms “consisting of” and “consisting essentially of” are subsumed in the term “comprising.” and the like.

The data center industry has created several data center consortiums in recent years to offer standardized data products and to encourage data/computer sever suppliers to build servers with higher data rates. Common printed circuit board (PCB) and cabling materials available today require improvements as data rates continue to increase. As a result, special high-performance materials are being developed, but these materials can be costly. For some applications, a costly repeater/retimer component may be necessary when using common PCB materials to improve signal quality over long circuit traces, connectors, and cables. Twinaxial cables, or “Twinax”, may be used to eliminate or minimize the need for costly PCB materials and repeater/retimers. A Mini Cool Edge IO (MCIO) application can be designed to work with a number of interfaces, and improved interface designs for a cable assembly and/or a mating connector can enhance connection security, mechanical rigidity, and ease of manual connection or disconnection. Disclosed embodiments of cable assemblies can be used in next generation server applications which support PCle Gen4/Gen5 protocols and speeds.

Also desirable is a pull-tab activation device for disconnecting the cable assembly from the board-mount connector. Such technologies can relate to Slimline products, such as standard Slimline, 24 mm mini Slimline, LPIO, and MCIO paddle-card interfaces, etc.

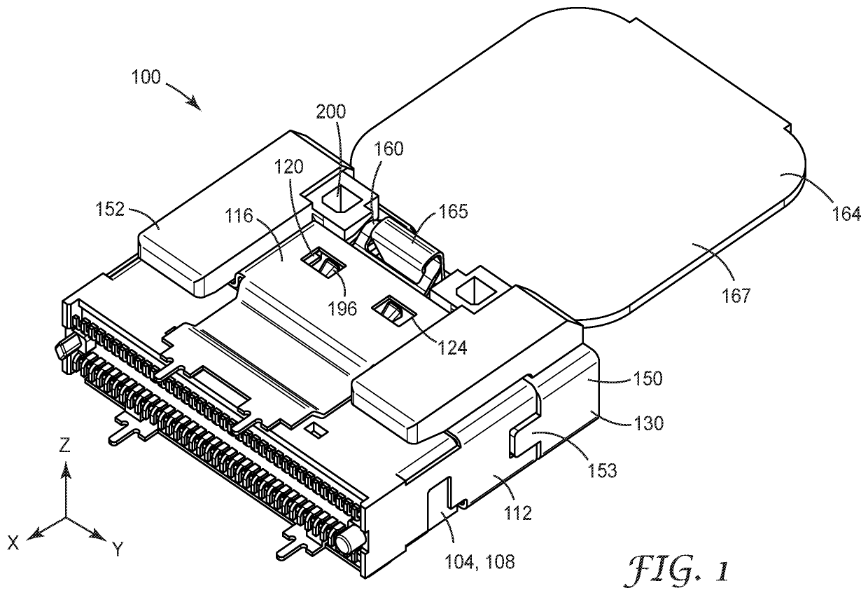

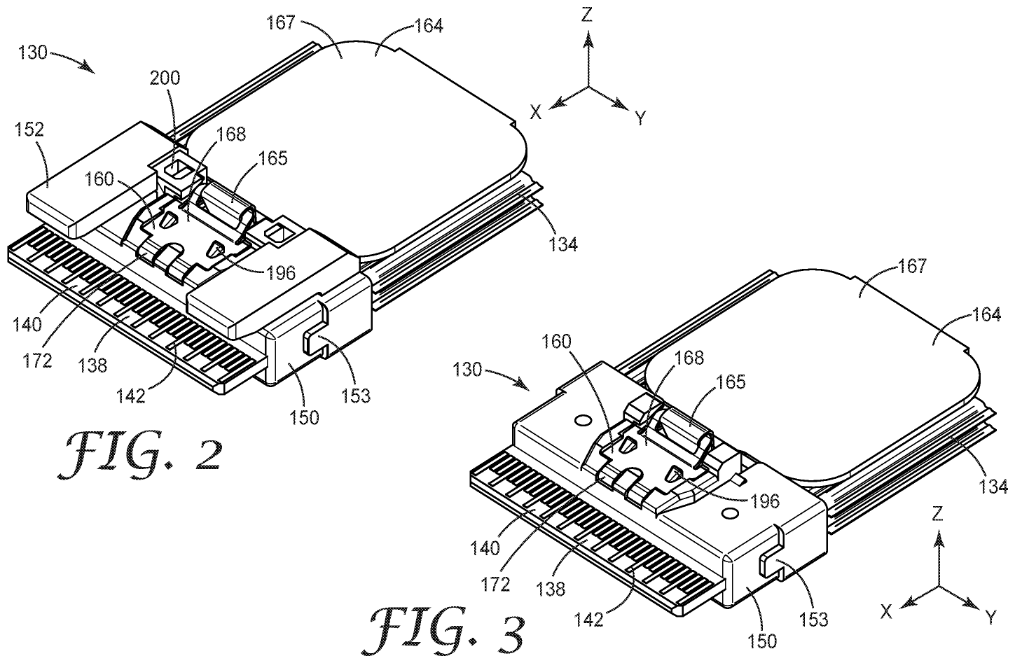

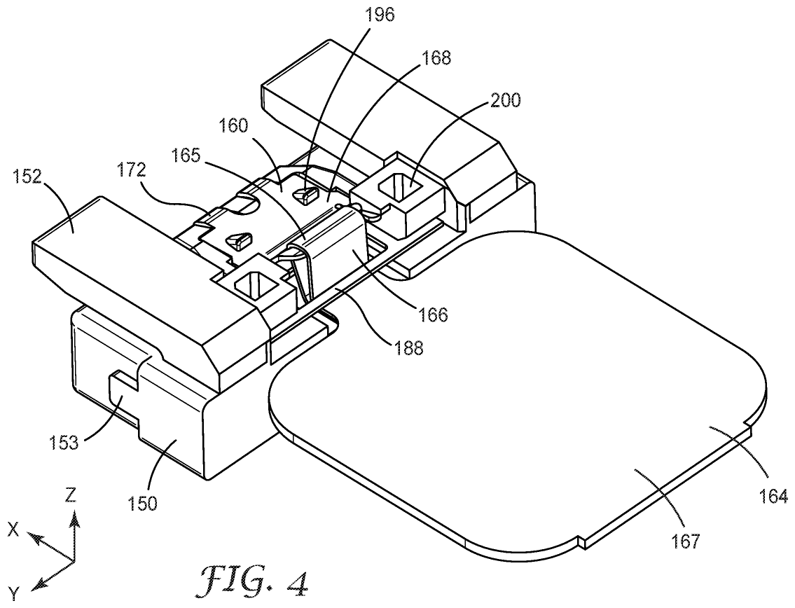

Turning to the figures, FIG. 1 is an upper perspective view of a connector system, showing a mating connector and a cable assembly in an attached position, FIG. 2 is an upper perspective view of a cable assembly, FIG. 3 is an upper perspective view of a cable assembly, different from that shown in FIG. 2, and FIG. 4 is an upper perspective view of a cable assembly, shown with the cables removed, according to exemplary embodiments of the present disclosure. Together, the cable assembly 130 and the mating connector 104 can form a connector system 100, and the cable assembly 130 and the mating connector 104 can releasably connect to one another as exemplarily shown in FIG. 1. It is to be understood that the disclosed mating connector 104 and/or board mount connector 108 are shown and described as merely exemplary elements, and that a wide range of mating connectors 104 and/or board mount connectors 108 are within the scope of this disclosure and can connect to the disclosed cable assembly 130 in the manners disclosed and shown. Similarly, it is to be understood that the disclosed cable assembly 130 is shown and described as a merely exemplary element, and that a wide range of cable assemblies 130 are within the scope of this disclosure and can connect to the disclosed mating connector 104 in the manners disclosed and shown.

As exemplarily shown in FIGS. 1-4, among others, the mating connector 104 (which can also be a board mount connector 108) can include a cage 112 and a latching portion 116. The latching portion 116 can be formed on the cage 112 or on another portion of the mating connector 104. The latching portion 116 can include one or more mating connector latching features 120. The mating connector latching feature 120 can be an aperture 124, a cavity, protrusion, or a particular shape on the latching portion 116. The cage 112 and/or latching portion 116 can provide structural support for engagement and securement, and can also provide an engagement interface for the mating connector 104.

The cable assembly 130 can include one or more cables 134 and a Printed Circuit Board (PCB) 138. The cables 134 can be Twinax cables and can parallel to, or substantially parallel to, one another. The PCB 138 can define a mating portion 140 and one or more electrically conductive contact pads 142. The PCB can have a thickness of 1.57, or about 1.57, mm. As can be seen in the figures, an X direction can be orthogonal to a Y direction, and each of the X direction and the Y direction can be orthogonal to a Z direction. For clarity, moving rearwardly along the X direction can indicate moving from the PCB 138 along the cables 134 or pull 164 towards the upper-right in FIGS. 1-3, while moving forwardly along the X direction can indicate the opposite direction. Further, moving upwardly along the Z direction can indicate moving upward vertically, as shown in FIGS. 1-3, while moving downwardly along the Z direction can indicate the opposite direction. Moving to the lower right, from the perspective of FIGS. 1-3, can indicate moving forwardly in the Y direction, whereas moving in the opposite direction can indicate moving rearwardly in the Y direction.

The mating connector 104 can releasably or permanently connect with the cable assembly 130 in an electrical and/or mechanical fashion. The mating connector 104 can receive a portion of the PCB 138, such as the mating portion 140, and can electrically connect to one or more conductive contact pads 142 on the PCB 138. In some embodiments, the conductive pads 142 can be disposed on the mating portion 140 of the PCB 138. The cables 134 can be electrically connected to portions of the PCB 138, which can be rear portions of the PCB 138.

The cable assembly 130 can also include a housing 150, which can also be termed a cable assembly main body or an overmold. The housing 150 can be proximate and/or in contact with the PCB 138 and, in some embodiments, can circumscribe, encapsulate, partially circumscribe or partially encapsulate a portion of the PCB 138, such as a rear portion of the PCB 138 as measured along the X direction. The housing 150 can include electrically insulating, or substantially insulating, materials such as, but not limited to, polymers, rubbers, ceramics, organic materials, metals, carbon, and metal alloys. As can be seen in the figures, the housing 150 can define and include a variety of shapes and features. In some embodiments, such as those shown in FIG. 2, the housing 150 can include one or more guides or projections 152. These guides 152 can extend forwardly from the housing 150 along the X axis, and can attach to various portions of the housing 150 and/or PCB 138. Additionally, lateral guides 153 can be disposed on lateral (spaced apart along the Y axis) surfaces of the housing 150. The guides 152, 153 can help to facilitate the initial and continued connection between the mating connector 104 and the cable assembly 130.

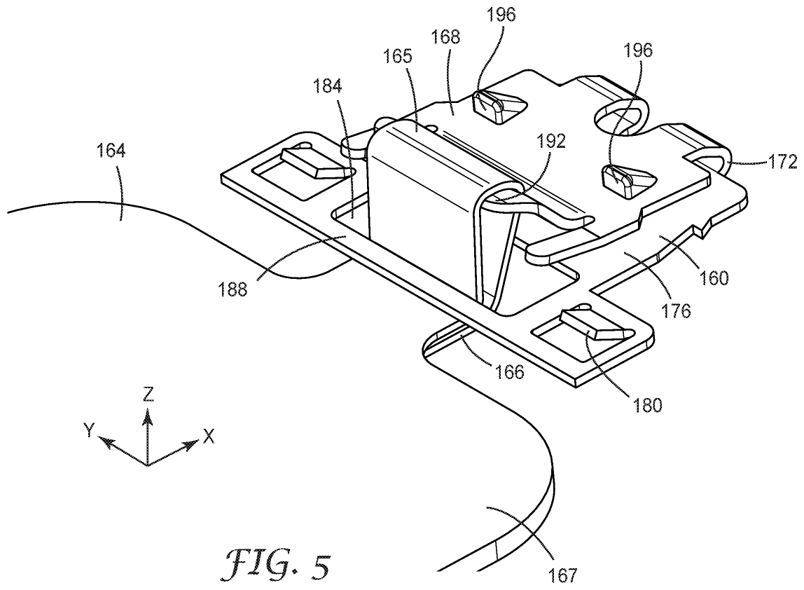

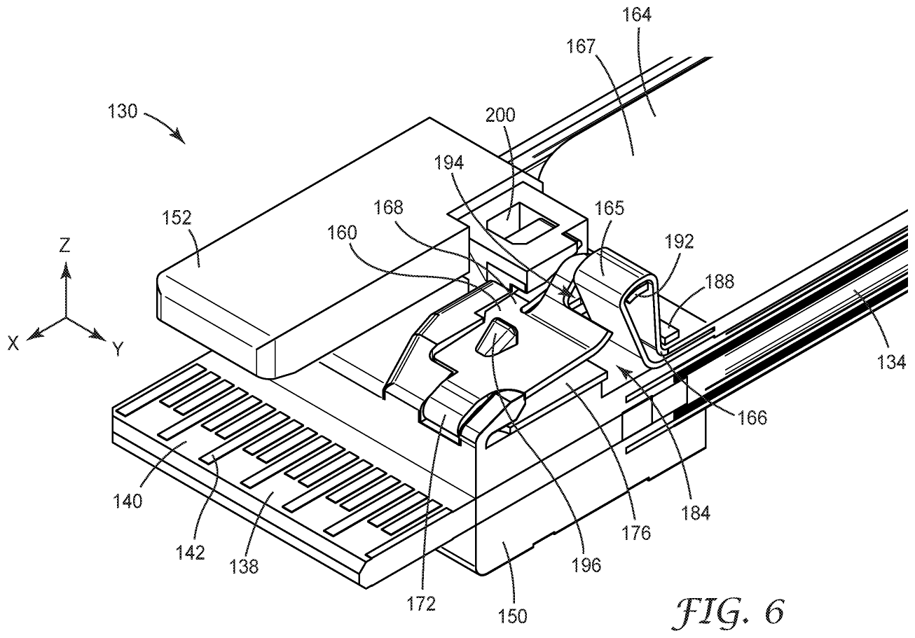

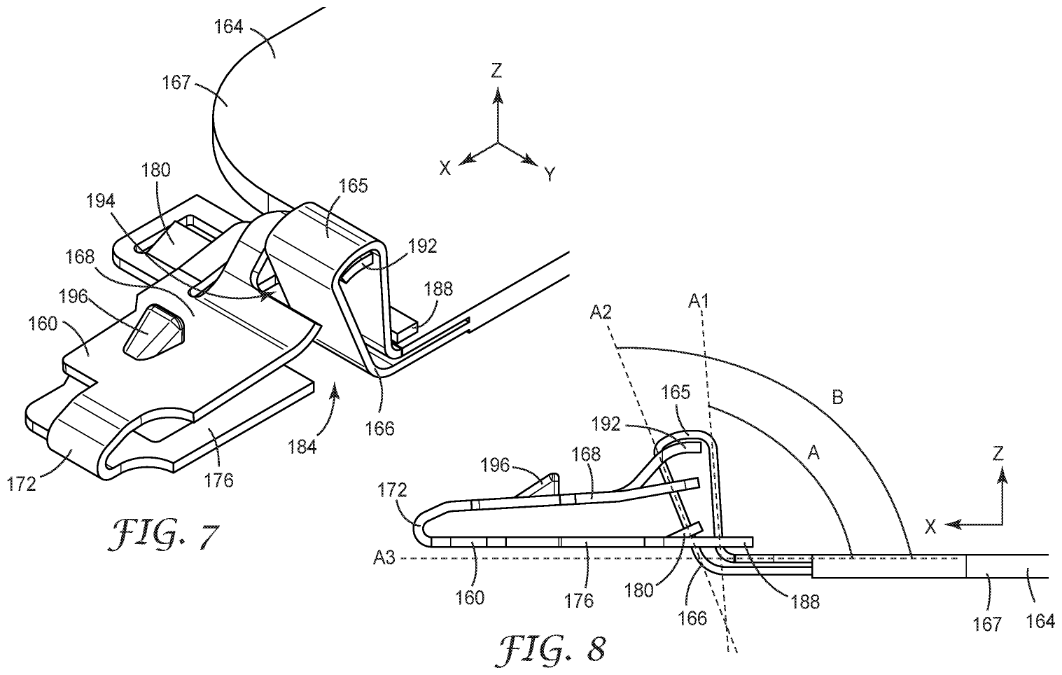

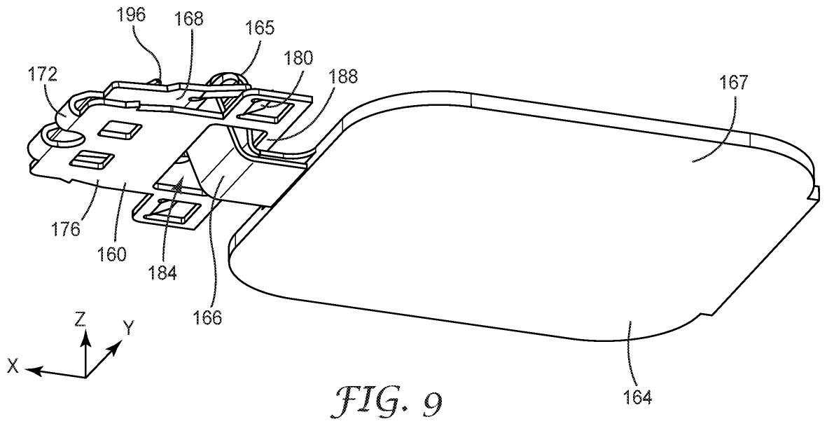

Turning to FIGS. 5-9, a latch 160 and a pull 164 (also visible in FIGS. 1-4) can be seen in further detail. FIG. 5 is an upper perspective view of a latch and a pull, FIG. 6 is a perspective cross sectional view of a cable assembly, FIG. 7 is an upper perspective cross sectional view of a latch and a pull, FIG. 8 is a side elevation view of a latch and a pull, and FIG. 9 is a lower perspective view of a latch and a pull, according to exemplary embodiments of the present disclosure. The pull 164 can include a flexible material, such as a polymer, fabric, braided cable, string, organic material, or any other suitable material known to those skilled in the art. The pull 164 can define a connection portion 165, a transition portion 166, and a pull tab portion 167. In various embodiments, the pull tab portion 167 can be disposed rearwardly from the connection portion 165 and/or the transition portion 166 as measured along the X axis. In some embodiments, the connection portion 165 can be disposed above one or more of the transition portion 166 and the pull tab portion 167, as measured along the Z axis.

The latch 160 can include an upper portion 168, a flexible portion or hinge 172 and a lower portion 176. The upper portion 168 can be disposed above, as measured along the Z axis, one or both of the flexible portion 172 and the lower portion 176. The flexible portion 172 can be disposed above, as measured along the Z axis, the lower portion 176. The lower portion 176 can define a retention feature 180, a lower pull aperture 184, and a lower pull cross member 188. The lower pull cross member 188 can extend substantially along the Y axis and the lower pull aperture 184 can be an area partially or fully bounded by the lower pull cross member 188 and the lower portion 176.

The upper portion 168 can define an upper pull cross member 192, an upper pull aperture 194, and one or more selective securement features 196. The upper pull cross member 192 can extend substantially along the Y axis and the upper pull aperture 194 can be an area partially or fully bounded by the upper pull cross member 192 and the upper portion 168.

The pull 164 can connect to one or more portions of the latch 160 and further can be in contact with one or more other portions of the latch 160. In some embodiments, the connection portion 165 can, releasably or permanently, connect to a portion of the latch 160 or to the upper portion 168. In some embodiments, a portion of the pull 164 or a portion of the connection portion 165 can pass through the upper pull aperture 194. In some embodiments, a portion of the pull 164 or a portion of the connection portion 165 can (fully or partially) loop around and circumscribe the upper pull cross member 192.

In some embodiments, a portion of the pull 164 or a portion of the transition portion 166 can pass through the lower pull aperture 184. In some embodiments, a portion of the pull 164 or a portion of the transition portion 166 can fully or partially wrap around (or travel around) the lower pull cross member 188. Portions of the pull 164 or the transition portion 166 can travel, can travel about, can travel at least, or can travel at most: 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, or 180 degrees around the lower pull cross member 188.

In some embodiments, portions of the pull 164 or the transition portion 166 can travel around the lower pull cross member 188 such that two pull 164 portions extending away from the lower pull cross member 188 (such as a pull 164 portion between the connection portion 165 and the transition portion 166 and a pull 164 portion between the transition portion 166 and the pull tab portion 167) are separated by an angle of, about, at most or at least: 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, or 180 degrees. In various embodiments, axes A1 and A2 can extend along portions of the pull 164 between the connection portion 165 and the transition portion 166, and axis A3 can extend along portions of the pull 164 between the pull tab portion 167 and the transition portion 166. Angle A can be defined as being formed between A1 and A3, and angle A can be, can be about, can be at most, or can be at least: 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, or 180 degrees. Angle B can be defined as being formed between A2 and A3, and angle B can be, can be about, can be at most, or can be at least: 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, or 180 degrees.

The pull tab portion 167 can extend rearwardly along the X axis from the latch 160, lower portion 176, lower pull cross member 188, transition portion 166, and/or connection portion 165. The pull tab portion 167 can include a shape designed for a user or a machine to pull rearwardly along the X axis and/or upwardly or downwardly along the Z axis. The pull tab portion 167 can include any shape suitable for pulling, such circles, squares, triangles, ovals, rectangles, pentagons, hexagons, heptagons, octagons, organic shapes, partially-organic shapes, parallelograms, polygons, and non-polygonal organic shapes.

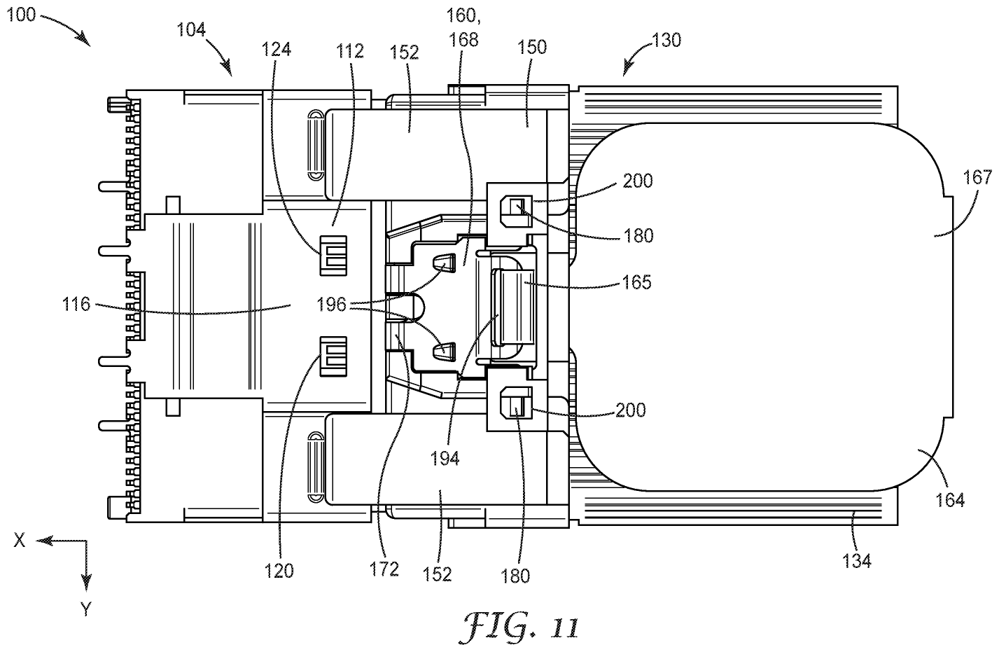

As mentioned above, the latch 160 can also include one or more retention features 180. The retention feature 180 can be any shape, protrusion, mechanism, material, or joining method that can permanently or releasably secure the latch 160 to the cable assembly 130 or the housing 150. As shown in the figures, and exemplarily in FIGS. 5 and 11, the retention feature 180 can be an upward-protruding (as measured along the Z-axis) element formed on the lower portion 176. In some embodiments, the retention feature 180 can be at least partially inserted into, or connect with, a housing retention feature 200. The retention feature 180 can deform during the insertion or connection with the housing retention feature 200, and can elastically return to a different or original shape or position following insertion or connection to thereby permanently or releasably secure the latch 160 to the housing 150 or cable assembly 130.

In operation, a user or machine can pull the pull tab portion 167 rearwardly along the X axis and/or upwardly or downwardly along the Z axis. This can translate a portion of the pull 164 rearward along the X axis and further can cause the transition portion 166 to slide around, wrap around, travel around, or pivot around the lower pull cross member 188. This can, in turn, cause the connection portion 165 to translate downwardly along the Z axis. As the connection portion 165 can be connected to the upper portion 168 of the latch 160, the upper portion 168 can translate downwardly along the Z axis with the connection portion 165 as the upper portion 168 translates and/or rotates with respect to the lower portion 176 due to elastic flexing of the latch 160 at the flexible portion 172.

The one or more selective securement features 196 can be disposed on the upper portion 168. Thus, the selective securement features 196 can translate upwardly or downwardly on the Z axis with the upper portion 168 and the connection portion 165. The selective securement feature 196 can be of any shape, size or mechanism, such as a hook, protrusion, clip, or any other selective securement technology known to those skilled in the art.

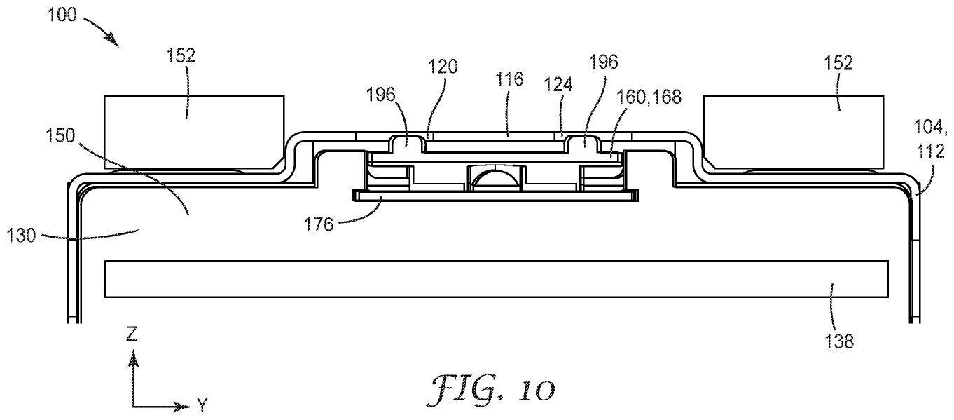

Turning to FIG. 10, FIG. 10 is a cross sectional view of a mating connector 104, cage 112, latch 160, and cable assembly 130, according to exemplary embodiments of the present disclosure. FIG. 10 shows a position where the latch 160 is in a relaxed, or an original, position. In such a position, as can be seen in FIG. 10, the selective securement features 196 can be seen at a same vertical position as measured along the Z axis as at least one of the latching portion 116, mating connector latching feature 120 and/or aperture 124, thus preventing a translation of elements of the cable assembly 130 (such as the latch 160, housing 150, and selective securement features 196) relative to elements of the mating connector 104 (such as the cage 112, latching portion 116, and aperture 124) along the X axis. In this way, the cable assembly 130 and the mating connector 104 are selectively connected.

Upon pulling the pull tab portion 167 rearwardly along the X axis and/or upwardly or downwardly along the Z axis as described above, the connection portion 165 and upper portion 168 can translate downwardly along the Z axis. This can cause the selective securement features 196 to translate to a lower vertical position as measured along the Z axis from at least one of the latching portion 116, mating connector latching feature 120 and/or aperture 124, thus allowing a translation of elements of the cable assembly 130 (such as the latch 160, housing 150, and selective securement features 196) relative to elements of the mating connector 104 (such as the cage 112, latching portion 116, and aperture 124) along the X axis. In this way, the cable assembly 130 and the mating connector 104 can be disconnected.

The disclosed embodiments provide numerous benefits and mechanisms for the efficient, secure, and stable operation of a connector system 100. In particular, the disclosed embodiments allow simplified cable assembly 130 manufacturing than prior technologies and provide a simple and effective latching-pull system for the secure and selective connection of a mating connector 104 and a cable assembly 130. Further, as the pull 164 interacts with numerous portions of the latch 160, other elements of the overall cable assembly 130 do not need to account for particular tolerances, interconnections, or pull 164 guides and pathways. Instead, the latch 160 itself provides much or all of the guidance and structure for proper latch 160 actuation in a cable assembly 130 having a reduced size and costs.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present disclosure. Thus, it should be understood that although the present disclosure has been specifically disclosed by specific embodiments and optional features, modification and variation of the concepts herein disclosed may be resorted to by those of ordinary skill in the art, and that such modifications and variations are considered to be within the scope of embodiments of the present disclosure. The complete disclosures of the patents, patent documents, and publications cited herein are incorporated by reference in their entirety as if each were individually incorporated. To the extent that there is any conflict or discrepancy between this specification as written and the disclosure in any document that is incorporated by reference herein, this specification as written will control.

What is claimed is:

1. A cable assembly, comprising:
a housing;
a latch connected to the housing, the latch defining a lower pull cross member; and
a pull disposed proximate the latch, a portion of the pull at least partially travelling around the lower pull cross member such that two pull portions extending away from the lower pull cross member are separated by an angle of at least about 30 degrees.

2. The cable assembly of claim 1, wherein the latch defines a retention feature and the latch is secured to the housing by the retention feature.

3. The cable assembly of claim 1, wherein the two pull portions extending away from the lower pull cross member are separated by an angle of at least about 40 degrees.

4. The cable assembly of claim 1, wherein the two pull portions extending away from the lower pull cross member are separated by an angle of at least about 50 degrees.

5. The cable assembly of claim 1, wherein the two pull portions extending away from the lower pull cross member are separated by an angle of at least about 60 degrees.

6. The cable assembly of claim 1, wherein the two pull portions extending away from the lower pull cross member are separated by an angle of at least about 70 degrees.

7. The cable assembly of claim 1, wherein the two pull portions extending away from the lower pull cross member are separated by an angle of at least about 80 degrees.

8. The cable assembly of claim 1, wherein the two pull portions extending away from the lower pull cross member are separated by an angle of at least about 90 degrees.

9. The cable assembly of claim 1, wherein the two pull portions extending away from the lower pull cross member are separated by an angle of at least about 100 degrees.

10. A cable assembly, comprising:
a housing;
a latch connected to the housing, the latch defining an upper portion and a lower portion, the upper portion defining an upper pull aperture and the lower portion defining a lower pull aperture; and
a pull disposed proximate the latch, a portion of the pull being disposed within the lower pull aperture and a portion of the pull being disposed within the upper pull aperture.

11. The cable assembly of claim 10, wherein at least one selective retention feature is disposed on the upper portion.

12. The cable assembly of claim 11, wherein the selective retention feature selectively secures the cable assembly to a mating connector.

13. The cable assembly of claim 10, wherein the lower portion defines a retention feature and the latch is secured to the housing by the retention feature.

14. A cable assembly, comprising:
a housing;
a latch connected to the housing, the latch defining an upper portion and a lower portion, the upper portion including an upper pull cross member and the lower portion defining a lower pull cross member; and
a pull disposed proximate the latch, a portion of the pull being disposed below the lower pull cross member as measured along a Z axis and a portion of the pull being looped around the upper pull cross member.

15. The cable assembly of claim 14, wherein a portion of the pull extends above the upper pull cross member as measured along the Z axis.

16. The cable assembly of claim 14, wherein at least one selective retention feature is disposed on the upper portion.

17. The cable assembly of claim 16, wherein the selective retention feature selectively secures the cable assembly to a mating connector.

18. The cable assembly of claim 14, wherein the lower portion defines a retention feature and the latch is secured to the housing by the retention feature.
